(19) United States
(12) Patent Application Publication
(10) Pub. No.: US 2026/0304242 A1
(43) Pub. Date: Oct. 1, 2026

(54) INFORMATION REPORTING METHOD, AND DEVICE

(71) Applicant: BEIJING XIAOMI MOBILE SOFTWARE CO., LTD., Beijing (CN)

(72) Inventor: Xing YANG, Beijing (CN)

(21) Appl. No.: 19/100,796

(22) PCT Filed: Aug. 5, 2022
(86) PCT No.: PCT/CN2022/110705

§ 371 Date: Feb. 3, 2025

(51) Int. Cl. H04W 36/00; H04W 4/20

(52) U.S. Cl. CPC H04W 36/0058; H04W 4/20; H04W 36/0085

(57) ABSTRACT

An information reporting method executed by a terminal device comprises: in response to a preset condition being met, reporting auxiliary information to a network-side device, wherein the auxiliary information is used for assisting the network-side device with performing mobility management, and the reporting of the auxiliary information is not triggered based on a measurement reporting condition being met.

### CROSS-REFERENCE TO RELATED APPLICATION

This application is the U.S. National Stage Application of International Application No. PCT/CN2022/110705, filed on Aug. 5, 2022, the entire disclosure of which is incorporated herein by reference.

### TECHNICAL FIELD

The present disclosure relates to a field of communication technology, and specifically to a method and an apparatus for reporting information.

### BACKGROUND

In a communication system, a terminal may perform measurement according to measurement configuration of a network device. Measurement result reporting of the terminal may be triggered when a measurement reporting condition is satisfied.

In the related art, it is not supported that information configured to assist the network device for mobility management is actively reported by the terminal. In this case, the terminal may not perform a cell handover, which may result in service interruption. This is an urgent problem to be solved.

### SUMMARY

According to a first aspect of the present disclosure, a method for reporting information is provided, executed by a terminal, including: in response to a preset condition being satisfied, reporting auxiliary information to a network device, in which the auxiliary information is configured to assist the network device to perform mobility management, and reporting the auxiliary information is not triggered based on a measurement reporting condition being satisfied.

According to a second aspect of the present disclosure, a method for reporting information is provided, executed by a network device, including: receiving auxiliary information reported by a terminal, in which the auxiliary information is configured to assist the network device to perform mobility management, the auxiliary information is reported by the terminal in the case that a preset condition is satisfied, and reporting the auxiliary information is not triggered based on a measurement reporting condition being satisfied.

According to a third aspect of the present disclosure, a terminal is provided, including a processor and a memory for storing a computer program. When the computer program stored in the memory is executed by the processor, the terminal is caused to implement the method in the first aspect.

### BRIEF DESCRIPTION OF THE DRAWINGS

In order to clearly illustrate technical solutions of the embodiments and the background of the present disclosure, a brief description of drawings used in embodiments and the background is given below.

FIG. 1 is a schematic diagram of an architecture of a communication system according to the embodiments of the present disclosure.

FIG. 2 is a flowchart of a method for reporting information according to the embodiments of the present disclosure.

FIG. 3 is a flowchart of another method for reporting information according to the embodiments of the present disclosure.

FIG. 4 is a flowchart of another method for reporting information according to the embodiments of the present disclosure.

FIG. 5 is a flowchart of another method for reporting information according to the embodiments of the present disclosure.

FIG. 6 is a flowchart of another method for reporting information according to the embodiments of the present disclosure.

FIG. 7 is a flowchart of another method for reporting information according to the embodiments of the present disclosure.

FIG. 8 is a flowchart of another method for reporting information according to the embodiments of the present disclosure.

FIG. 9 is a flowchart of another method for reporting information according to the embodiments of the present disclosure.

FIG. 10 is a block diagram of a communication apparatus according to the embodiments of the present disclosure.

FIG. 11 is a block diagram of another communication device according to the embodiments of the present disclosure.

FIG. 12 is a block diagram of a chip according to the embodiments of the present disclosure.

### DETAILED DESCRIPTION

In order to better understand the method and the apparatus for reporting information in the embodiments of the present disclosure, a communication system to which the embodiments of the present disclosure is applicable is first described as follows.

Please refer to FIG. 1, which is a schematic diagram of an architecture of a communication system according to the embodiments of the present disclosure. The communication system may include, but is not limited to, one network device and one terminal. The number and form of devices shown in the FIG. 1 are only shown as an example, and do not constitute a limitation on the embodiments of the present disclosure. The communication system may include two or more network devices and two or more terminals in a practical application. The communication system in the FIG. 1 including one network device 101 and one terminal 102 is shown as an example.

It needs to be noted that the technical solution of the embodiments of the present disclosure may be applied to various communication systems, for example, a long term evolution (LTE) system, a 5th generation (5G) mobile communication system, a 5G new radio (NR) system, or other new mobile communication systems in the future. It also needs to be noted that a sidelink in the embodiments of the present disclosure may also be called a side link or a direct link.

The network device 101 in the embodiments of the present disclosure is an entity on the network side for sending or receiving signals. For example, the network device 101 may be an evolved NodeB (eNB), a transmission reception point (TRP), a next generation NodeB (gNB) in an NR system, a base station in other mobile communication system in the future, or an access node in a wireless fidelity (WiFi) system. The embodiments of the present disclosure do not limit a specific technology and a specific device form used by the network device. The base station in the embodiments of the present disclosure may be consisted of a central unit (CU) and a distributed unit (DU), in which the CU may also be called a control unit. For example, a protocol layer of the base station may be divided by adopting a CU-DU structure. Some functions of the protocol layer are centrally controlled by the CU, and some or all of remaining functions of the protocol layer are distributed in the DU, which is centrally controlled by the CU.

The terminal 102 in the embodiments of the present disclosure is an entity on the user side for receiving or sending signals, such as a mobile phone. The terminal may also be called a user equipment (UE), a mobile station (MS), a mobile terminal (MT), etc. The terminal may be a car with communication function, a smart car, a mobile phone, a wearable device, a Pad, a computer with a wireless receiving and sending function, a virtual reality (VR) terminal, an augmented reality (AR) terminal, a wireless terminal in industrial control, a wireless terminal in autonomous driving, a wireless terminal in remote medical surgery, a wireless terminal in a smart grid, a wireless terminal in transportation safety, a wireless terminal in a smart city, a wireless terminal in a smart home, etc. The embodiments of the present disclosure do not limit a specific technology and a specific device form used by the terminal.

It may be understood that the communication system in the embodiments of the present disclosure is to more clearly illustrate the technical solution of the embodiments of the present disclosure, and does not constitute a limitation on the technical solution in the embodiments of the present disclosure. Those skilled in the art may know, with the evolution of the system architecture and the emergence of new service scenarios, the technical solution in the embodiments of the present disclosure is also applicable to similar technical problems.

The method and the apparatus for reporting information in the present disclosure are introduced below in detail in combination with attached drawings.

In the related art, the terminal performs measurement according to measurement configuration of the network device. The measurement configuration may include a measurement object, a report configuration (config), a quantity config, etc.

The measurement object indicates a frequency and a cell needs to be measured and may include a variety of access technologies, including a new radio (NR) cell, a long term evolution (LTE) cell, or an evolved UMTS terrestrial radio access network (E-UTRAN) cell. Each measurement object is bound to a measurement object index identity (measObject Index ID).

The report configuration indicates a type reported by the terminal, including a periodic reporting and an event-based reporting. Carrying reporting timer configuration is used to trigger measurement reporting. A reporting timer includes a T321, a T322, and a Time To Trigger. Different report configurations may be applied to measurement objects of different access technologies. Each report configuration is bound to a reportconfig ID.

Event-based report configuration may provide following configuration:

a type of a signal that triggers reporting includes a reference signal receiving power (RSRP), a reference signal receiving quality (RSRQ), or a signal to interference plus noise ratio (SINR);

a threshold or offset; and

a measurement result of the reporting, including the RSRP, the RSRQ or the SINR.

The terminal compares a relationship between a signal measurement result of a serving cell and a signal measurement result of a neighbour cell, a relationship between the signal measurement result of the serving cell and a threshold of the serving cell, a relationship between the signal measurement result of the neighbour cell and a threshold of the neighbour cell. If a requirement of the threshold is satisfied, measurement result reporting may be triggered.

Event-based measurement reporting includes events A1-A6, events B1-B2, an event D1, an event T1, etc. The series of A events are used for intra-system mobility management. The series of B events are used for inter-system mobility management. D1 and T1 are used for satellite system mobility management. The series of A reporting events are as follows:

Event A1: Serving becomes better than absolute threshold;

Event A2: Serving becomes worse than absolute threshold;

Event A3: Neighbour becomes amount of offset better than PCell/PSCell;

Event A4: Neighbour becomes better than absolute threshold;

Event A5: PCell/PSCell becomes worse than absolute threshold1 AND Neighbour/SCell becomes better than another absolute threshold2;

Event A6: Neighbour becomes amount of offset better than SCell.

In the related art, in a handover process, the network device may configure the terminal to perform measurement. According to the measurement result reported by the terminal, the network device sends a handover request to a handover target cell, and sends a handover command (e.g., reconfiguration with sync) to the terminal carrying configuration information of the handover target cell after the handover target cell is confirmed. After receiving the reconfiguration with sync, the terminal may synchronize with the handover target cell, and then initiate a random access process to access the handover target cell.

However, a measurement reporting condition configured by the network device to the terminal may be unreasonable. For example, if measurement reporting based on the RSRP is configured, the RSRP of a serving cell corresponding to the terminal is good, but the RSRQ is poor, then the measurement reporting may not be triggered in this case, which may result in failing to perform a cell handover by the terminal and thus result in the service interruption. For another example, a signal quality of a current cell is good, but the terminal may not obtain uplink and downlink resources scheduled by the network device for a long time (there are many terminals served by the current cell, which leads to communication congestion, etc.), the terminal may not perform the cell handover at this time, which may result in the service interruption and so on.

Based on this, a method and an apparatus for reporting information are provided. When the preset condition is satisfied, the terminal may report the auxiliary information to the network device, in which the auxiliary information is configured to assist the network device to perform the mobility management, and reporting the auxiliary information is not triggered based on the measurement reporting condition being satisfied. In this way, the terminal may actively report the information configured to assist the network device for the mobility management and actively perform the cell handover to avoid the service interruption.

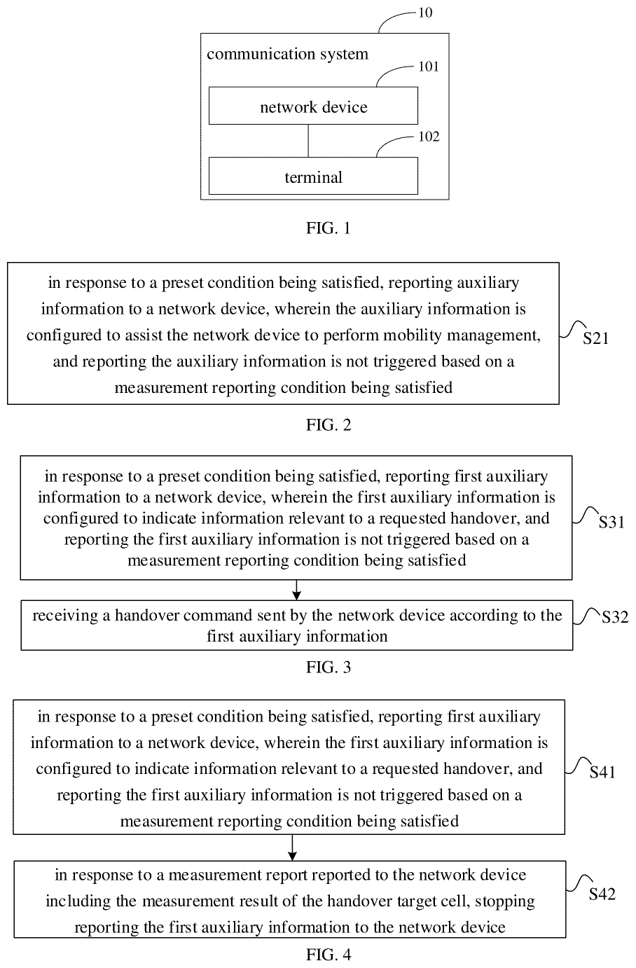

Please refer to FIG. 2, which is a flowchart of a method for reporting information according to the embodiments of the present disclosure.

As shown in the FIG. 2, the method is executed by a terminal, and may include but is not limited to the following step S21.

At S21, in response to a preset condition being satisfied, auxiliary information is reported to a network device, in which the auxiliary information is configured to assist the network device to perform mobility management, and reporting the auxiliary information is not triggered based on a measurement reporting condition being satisfied.

In the embodiments of the present disclosure, when the preset condition is satisfied, the terminal may report the auxiliary information to the network device, in which the auxiliary information is configured to assist the network device to perform the mobility management.

The auxiliary information may be information relevant to a requested handover, such as a requested handover indication, a handover target cell, a measurement result of the handover target cell, and/or a handover cause, etc. The auxiliary information may be configuration relevant to measurement reporting configured by the network device, such as an identifier of a measurement reporting event, a type of a signal that triggers the measurement reporting, a measurement reporting cycle, a measurement object, and/or a time of triggering the measurement reporting, etc.

In the embodiments of the present disclosure, when the preset condition is satisfied, the terminal may report the information relevant to the requested handover to the network device and actively apply for the cell handover to complete the cell handover so as to avoid the service interruption. When the preset condition is satisfied, the terminal reports and requests the configuration relevant to the measurement reporting configured by the network device to the network device, and the network device may configure a reasonable measurement reporting condition for the terminal considering the configuration relevant to the measurement reporting reported by the terminal, so that the terminal may complete the cell handover and avoid the service interruption.

It may be understood that reporting the auxiliary information is not triggered based on the measurement reporting condition being satisfied, but the terminal actively reports the auxiliary information.

In the embodiments of the present disclosure, the terminal may perform local measurement on a service quality of a serving cell and/or a neighbour cell, and/or in consideration of its own communication requirements, etc., further determine whether to actively report the auxiliary information to the network device according to a measurement result and/or a communication requirement of the local measurement.

By implementing the embodiments of the present disclosure, when the preset condition is satisfied, the terminal reports the auxiliary information to the network device, in which the auxiliary information is configured to assist the network device to perform the mobility management, and reporting the auxiliary information is not triggered based on the measurement reporting condition being satisfied. In this way, the terminal may actively report the information configured to assist the network device for the mobility management and actively perform the cell handover to avoid the service interruption.

In some embodiments, the preset condition includes at least one of:

a condition that an uplink resource scheduled by the network device is not received within a specific duration;

a condition that a downlink resource scheduled by the network device is not received within a specific duration;

a condition that a signal quality of a serving cell is lower than a signal quality threshold and a measurement result is not reported; or

a condition that the signal quality of the serving cell is lower than the signal quality threshold and a handover is not performed.

In the embodiments of the present disclosure, in the condition that the terminal does not receive the uplink resource scheduled by the network device within the specific duration, the terminal reports the auxiliary information configured to perform the mobility management to the network device.

In the embodiments of the present disclosure, in the condition that the terminal does not receive the downlink resource scheduled by the network device within the specific duration, the terminal reports the auxiliary information configured to perform the mobility management to the network device.

It may be understood that when the terminal does not receive the uplink resource and/or the downlink resource scheduled by the network device within the specific duration, the signal quality of the serving cell is good, and the network device does not send the measurement configuration to the terminal, but the terminal does not receive the uplink resource and/or the downlink resource scheduled by the network device within the specific duration. It is indicated that at this time, there are many terminals served by the serving cell, with the communication congestion. In this case, the terminal may report the auxiliary information to the network device to actively apply for the cell handover so as to avoid the service interruption.

In the embodiments of the present disclosure, in the condition that the signal quality of the serving cell is lower than the signal quality threshold and the measurement result is not reported, the terminal reports the auxiliary information configured to perform the mobility management to the networking device.

It may be understood that the signal quality of the serving cell is lower than the signal quality threshold and the measurement result is not reported, which indicates that the measurement reporting condition configured by the network device may be unreasonable. In this case, the terminal may report the auxiliary information to the network device to actively apply for the cell handover so as to avoid the service interruption.

In the embodiments of the present disclosure, in the condition that the signal quality of the serving cell is lower than the signal quality threshold and the handover is not performed, the terminal reports the auxiliary information configured to perform the mobility management to the networking device.

It may be understood that the signal quality of the serving cell is lower than the signal quality threshold and the handover is not performed, which indicates that the target cell may not provide a communication service for the terminal, or information between any two of the terminal, the target cell and the network device may not be accurately sent, etc. In this case, the terminal may report the auxiliary information to the network device to actively apply for the cell handover so as to avoid the service interruption.

It needs to be noted that the above embodiments are not exhaustively listed and are only examples of part of the embodiments, and the above embodiments may be implemented alone or in combination with a plurality of embodiments. The above embodiments are merely exemplary and do not constitute as a specific limitation of the protection scope of the embodiments of the present disclosure.

In some embodiments, the terminal receives first indication information sent by the network device, in which the first indication information indicates the specific duration.

In the embodiments of the present disclosure, in the case that the terminal receives the first indication information sent by the network device and the first indication information indicates the specific duration, the specific duration may be determined, so that the terminal reports the auxiliary information configured to perform the mobility management to the network device in the condition that the uplink resource and the downlink resource scheduled by the network device are not received within the specific duration.

In addition to determining the specific duration according to the first indication information sent by the network device, the terminal may determine the specific duration in other ways, such as, according to an agreement in a protocol, according to indication information of the counterpart terminal, or based on the terminal implementation, etc., which is not specifically limited in the embodiments of the present disclosure.

In some embodiments, the terminal receives second indication information sent by the network device, in which the second indication information indicates the signal quality threshold.

In the embodiments of the present disclosure, in the case that the terminal receives the second indication information sent by the network device and the second indication information indicates the signal quality threshold, the signal quality threshold may be determined, so that the terminal reports the auxiliary information configured to perform the mobility management to the network device in the condition that the signal quality of the serving cell is lower than the signal quality threshold and the measurement result is not reported and/or in the condition that the signal quality of the serving cell is lower than the signal quality threshold and the handover is not performed.

In addition to determining the signal quality threshold according to the second indication information sent by the network device, the terminal may determine the specific duration in other ways, such as, according to an agreement in a protocol, according to indication information of the counterpart terminal, or based on the terminal implementation, etc., which is not specifically limited in the embodiments of the present disclosure.

In some embodiments, the auxiliary information includes first auxiliary information for indicating information relevant to a requested handover, in which the first auxiliary information includes at least one of:

a requested handover indication;

a handover target cell;

a measurement result of the handover target cell; or

a handover cause.

In the embodiments of the present disclosure, when the terminal reports the auxiliary information to the network device in response to satisfying the preset condition, the terminal may report the first auxiliary information for indicating the information relevant to the requested handover to the network device to actively apply for the cell handover so as to avoid the service interruption.

The first auxiliary information includes the requested handover indication. When the preset condition is satisfied, the terminal reports the requested handover indication to the network device, to actively apply for the cell handover so as to avoid the service interruption.

The first auxiliary information includes the handover target cell. When the preset condition is satisfied, the terminal reports the handover target cell to the network device, to actively apply to hand over to the handover target cell so as to avoid the service interruption.

The first auxiliary information includes the measurement result of the handover target cell. When the preset condition is satisfied, the terminal reports the measurement result of the handover target cell to the network device, to actively apply to hand over to the handover target cell so as to avoid the service interruption.

The first auxiliary information includes the handover cause. When the preset condition is satisfied, the terminal reports the handover cause to the network device, to actively apply for the cell handover so as to avoid the service interruption.

The handover cause may be that the uplink resource is not received or the downlink resource is not received, a channel quality of the serving cell is poor, or the service does not meet requirements, and so on.

It needs to be noted that the above embodiments are not exhaustively listed and are only examples of part of the embodiments, and the above embodiments may be implemented alone or in combination with a plurality of embodiments. The above embodiments are merely exemplary and do not constitute as a specific limitation of the protection scope of the embodiments of the present disclosure.

In one embodiment, the terminal receives a handover command sent by the network device according to the first auxiliary information.

In the embodiments of the present disclosure, when the preset condition is satisfied, the terminal may report the first auxiliary information for indicating the information relevant to the requested handover to the network device. After receiving the first auxiliary information reported by the terminal, the network device may consider the first auxiliary information and send the handover command to the terminal according to the first auxiliary information, to indicate the terminal to perform the cell handover, so as to avoid the service interruption of the terminal.

In some embodiments, in response to a measurement report reported to the network device including the measurement result of the handover target cell, the terminal may stop reporting the auxiliary information to the network device.

In the embodiments of the present disclosure, if the terminal has reported the measurement report to the network device and the measurement report reported includes the measurement result of the handover target cell. At this time, the terminal may stop reporting the auxiliary information to the network device, for example, stop reporting the first auxiliary information to the network device.

In some embodiments, in response to the measurement report reported to the network device including the measurement result of the handover target cell, the terminal stopping reporting the auxiliary information to the network device includes: in response to the measurement report reported to the network device including the measurement result of the handover target cell, starting a first timer, and stopping reporting the auxiliary information to the network device within a first timer duration of the first timer.

In the embodiments of the present disclosure, if the terminal has reported the measurement report to the network device and the measurement report reported includes the measurement result of the handover target cell, at this time, the terminal may stop reporting the auxiliary information to the network device, for example, stop reporting the first auxiliary information to the network device.

When the measurement report reported to the network device by the terminal includes the measurement result of the handover target cell, the terminal starts the first timer, and stops reporting the auxiliary information to the network device within the first timer duration of the first timer.

In some embodiments, the terminal receives first configuration information from the network device, in which the first configuration information indicates the first timer duration.

In the embodiments of the present disclosure, the terminal receives the first configuration information sent by the network device and determines the first timer duration of the first timer according to the first configuration information. When the measurement report reported to the network device by the terminal includes the measurement result of the handover target cell, the terminal starts the first timer, and stops reporting the auxiliary information to the network device within the first timer duration of the first timer.

In some embodiments, the auxiliary information includes second auxiliary information for indicating and requesting configuration relevant to measurement reporting configured by the network device, in which the second auxiliary information includes at least one of:

an identifier of a measurement reporting event;

a type of a signal that triggers the measurement reporting;

a measurement reporting cycle;

a measurement object; or

a time of triggering the measurement reporting.

In the embodiments of the present disclosure, when the terminal reports the auxiliary information to the network device in response to satisfying the preset condition, the terminal reports the second auxiliary information for indicating and requesting the configuration relevant to the measurement reporting configured by the network device to the network device, to actively request the network device to configure corresponding measurement configuration information and to perform the cell handover, so as to avoid the service interruption.

The second auxiliary information includes the identifier of the measurement reporting event. When the preset condition is satisfied, the terminal reports the identifier of the measurement reporting event to the network device, to actively request the network device to configure measurement configuration information including the identifier of the measurement reporting event.

It may be understood that the identifier of the measurement reporting event may be an identifier of any one of events A1-A6, B1-B2, D1, T1, X1, X2, Y1 and Y2. For different events, a threshold or an offset value may also be indicated.

The second auxiliary information includes the type of the signal that triggers the measurement reporting. When the preset condition is satisfied, the terminal reports the type of the signal that triggers the measurement reporting to the network device, to actively request the network device to configure measurement configuration information including the type of the signal that triggers the measurement reporting.

It may be understood that the type of the signal that triggers the measurement reporting may be the RSRP, the RSRQ or the SINR.

The second auxiliary information includes the measurement reporting cycle. When the preset condition is satisfied, the terminal reports the measurement reporting cycle to the network device, to actively request the network device to configure measurement configuration information including the measurement reporting cycle.

It may be understood that the measurement reporting cycle may be single reporting or periodic reporting. The measurement reporting cycle may indicate a cycle length.

The second auxiliary information includes the measurement object. When the preset condition is satisfied, the terminal reports the measurement object to the network device, to actively request the network device to configure measurement configuration information including the measurement object.

It may be understood that the measurement object may be a frequency or an identifier of the target cell, etc.

The second auxiliary information includes the time of triggering the measurement reporting. When the preset condition is satisfied, the terminal reports the time of triggering the measurement reporting to the network device, to actively request the network device to configure measurement configuration information including the time of triggering the measurement reporting.

It needs to be noted that the above embodiments are not exhaustively listed and are only examples of part of the embodiments, and the above embodiments may be implemented alone or in combination with a plurality of embodiments. The above embodiments are merely exemplary and do not constitute as a specific limitation of the protection scope of the embodiments of the present disclosure.

In some embodiments, the terminal receives measurement configuration information sent by the network device according to the second auxiliary information.

In the embodiments of the present disclosure, when the preset condition is satisfied, the terminal reports the second auxiliary information for indicating and requesting the configuration relevant to the measurement reporting configured by the network device to the network device. After receiving the second auxiliary information reported by the terminal, the network device may consider the second auxiliary information and send the measurement configuration information to the terminal according to the second auxiliary information, to indicate the terminal to report the measurement result and perform the cell handover, so as to avoid the service interruption of the terminal.

In some embodiments, the terminal starts a second timer after the auxiliary information is reported to the network device, and stop reporting the auxiliary information to the network device within a second timer duration of the second timer.

In the embodiments of the present disclosure, when the preset condition is satisfied, the terminal reports the auxiliary information to the network device, in which the auxiliary information is configured to assist the network device to perform the mobility management, and reporting the auxiliary information is not triggered based on the measurement reporting condition being satisfied; and the terminal starts the second timer after the auxiliary information is reported to the network device, and stops reporting the auxiliary information to the network device within the second timer duration of the second timer, which may avoid the terminal from repeatedly reporting the auxiliary information, and save energy consumption of the terminal.

In some embodiments, the terminal may receive second configuration information from the network device, in which the second configuration information indicates the second timer duration.

In the embodiments of the present disclosure, the terminal receives the second configuration information from the network device, in which the second configuration information indicates the second timer duration. In this way, the terminal starts the second timer after the auxiliary information is reported to the network device, and stops reporting the auxiliary information to the network device within the second timer duration of the second timer, which may avoid the terminal from repeatedly reporting the auxiliary information, and save energy consumption of the terminal.

Please refer to FIG. 3, which is a flowchart of another method for reporting information according to the embodiments of the present disclosure.

As shown in the FIG. 3, the method is executed by a terminal, and may include but is not limited to the following steps S31 to S32.

At S31, in response to a preset condition being satisfied, first auxiliary information is reported to a network device, in which the first auxiliary information is configured to indicate information relevant to a requested handover, and reporting the first auxiliary information is not triggered based on a measurement reporting condition being satisfied.

The relevant description of the preset condition may be referred to the relevant description of the preset condition in the above embodiments, which may not be repeated herein.

In the embodiments of the present disclosure, when the preset condition is satisfied, the terminal reports the first auxiliary information to the network device, in which the first auxiliary information is configured to indicate the information relevant to the requested handover.

The first auxiliary information includes at least one of:

a requested handover indication;

a handover target cell;

a measurement result of the handover target cell; or

a handover cause.

In the embodiments of the present disclosure, when the terminal reports the auxiliary information to the network device in response to satisfying the preset condition, the terminal may report the first auxiliary information for indicating the information relevant to the requested handover to the network device, to actively apply for the cell handover so as to avoid the service interruption.

The first auxiliary information includes the requested handover indication. When the preset condition is satisfied, the terminal reports the requested handover indication to the network device, to actively apply for the cell handover so as to avoid the service interruption.

The first auxiliary information includes the handover target cell. When the preset condition is satisfied, the terminal reports the handover target cell to the network device, to actively apply to hand over to the handover target cell so as to avoid the service interruption.

The first auxiliary information includes the measurement result of the handover target cell. When the preset condition is satisfied, the terminal reports the measurement result of the handover target cell to the network device, to actively apply to hand over to the handover target cell so as to avoid the service interruption.

The first auxiliary information includes the handover cause. When the preset condition is satisfied, the terminal reports the handover cause to the network device, to actively apply to hand over the cell so as to avoid the service interruption.

The handover cause may be that the uplink resource is not received or the downlink resource is not received, a channel quality of the serving cell is poor, or the service does not meet requirements, and so on.

It needs to be noted that the above embodiments are not exhaustively listed and are only examples of part of the embodiments, and the above embodiments may be implemented alone or in combination with a plurality of embodiments. The above embodiments are merely exemplary and do not constitute as a specific limitation of the protection scope of the embodiments of the present disclosure.

At S32, a handover command sent by the network device according to the first auxiliary information is received.

In the embodiments of the present disclosure, when the preset condition is satisfied, the terminal reports the first auxiliary information for indicating the information relevant to the requested handover to the network device. After receiving the first auxiliary information reported by the terminal, the network device may consider the first auxiliary information and send the handover command to the terminal according to the first auxiliary information, to indicate the terminal to perform the cell handover, so as to avoid the service interruption of the terminal.

By implementing the embodiments of the present disclosure, when the preset condition is satisfied, the first auxiliary information is reported to the network device, in which the first auxiliary information is configured to indicate the information relevant to the requested handover, and reporting the first auxiliary information is not triggered based on the measurement reporting condition being satisfied; and the handover command sent by the network device according to the first auxiliary information is received. In this way, the terminal may actively apply for the cell handover and perform the cell handover to avoid the service interruption.

Please refer to FIG. 4, which is a flowchart of another method for reporting information according to the embodiments of the present disclosure.

As shown in the FIG. 4, the method is executed by a terminal, and may include but is not limited to the following steps S41 to S42.

At S41, in response to a preset condition being satisfied, first auxiliary information is reported to a network device, in which the first auxiliary information is configured to indicate information relevant to a requested handover, and reporting the first auxiliary information is not triggered based on a measurement reporting condition being satisfied.

In the embodiments of the present disclosure, the relevant description of the S41 may be referred to the relevant description in the above embodiments, which may not be repeated herein.

At S42, in response to a measurement report reported to the network device including the measurement result of the handover target cell, reporting the first auxiliary information to the network device is stopped.

In the embodiments of the present disclosure, if the terminal has reported the measurement report to the network device and the measurement report reported includes the measurement result of the handover target cell. At this time, the terminal may stop reporting the first auxiliary information to the network device.

In some embodiments, in response to the measurement report reported to the network device including the measurement result of the handover target cell, the terminal stopping reporting the auxiliary information to the network device includes: in response to the measurement report reported to the network device including the measurement result of the handover target cell, starting a first timer, and stopping reporting the auxiliary information to the network device within a first timer duration of the first timer.

In the embodiments of the present disclosure, if the terminal has reported the measurement report to the network device and the measurement report reported includes the measurement result of the handover target cell. At this time, the terminal may stop reporting the auxiliary information to the network device, for example, stop reporting the first auxiliary information to the network device.

When the measurement report reported to the network device by the terminal includes the measurement result of the handover target cell, the terminal starts the first timer, and stops reporting the auxiliary information to the network device within the first timer duration of the first timer.

In some embodiments, the first timer may include: the T321, the T322 and the Time To Trigger.

In some embodiments, the terminal receives first configuration information from the network device, in which the first configuration information indicates the first timer duration.

In the embodiments of the present disclosure, the terminal receives the first configuration information sent by the network device and determines the first timer duration of the first timer according to the first configuration information. When the measurement report reported to the network device by the terminal includes the measurement result of the handover target cell, the terminal starts the first timer, and stops reporting the auxiliary information to the network device within the first timer duration of the first timer.

When the measurement report reported to the network device by the terminal includes the measurement result of the handover target cell, the terminal starts the T321. If the terminal receives the first configuration information from the network device indicating that the first timer duration is 5 minutes, the terminal stops reporting the first auxiliary information to the network device within 5 minutes.

It needs to be noted that in the embodiments of the present disclosure, the S41 and the S42 may be implemented alone or be implemented in combination with any one of other steps in the embodiments of the present disclosure, such as in combination with the S21, and/or the S31 and the S32 in the embodiments of the present disclosure, which is not limited in the embodiments of the present disclosure.

By implementing the embodiments of the present disclosure, when the preset condition is satisfied, the terminal reports the first auxiliary information to the network device, in which the first auxiliary information is configured to indicate the information relevant to the requested handover, and reporting the first auxiliary information is not triggered based on the measurement reporting condition being satisfied; and in response to the measurement report reported to the network device including the measurement result of the handover target cell, the terminal stops reporting the first auxiliary information to the network device, which may avoid the terminal from repeatedly reporting, and save energy consumption of the terminal.

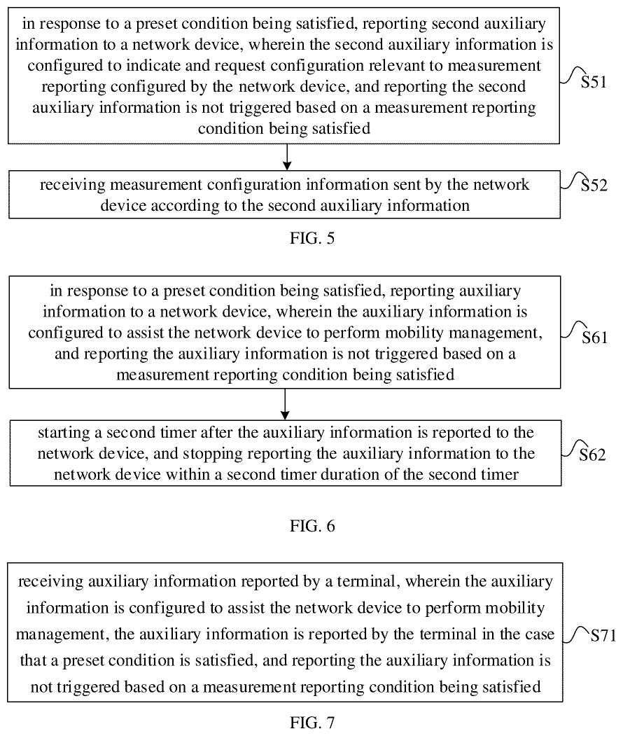

Please refer to FIG. 5, which is a flowchart of another method for reporting information according to the embodiments of the present disclosure.

As shown in the FIG. 5, the method is executed by a terminal, and may include but is not limited to the following steps S51 to S52.

At S51, in response to a preset condition being satisfied, second auxiliary information is reported to a network device, in which the second auxiliary information is configured to indicate and request configuration relevant to measurement reporting configured by the network device, and reporting the second auxiliary information is not triggered based on a measurement reporting condition being satisfied.

The relevant description of the preset condition may be referred to the relevant description of the preset condition in the above embodiments, which may not be repeated herein.

In the embodiments of the present disclosure, when the preset condition is satisfied, the terminal reports the second auxiliary information to the network device, in which the second auxiliary information is configured to indicate and request the configuration relevant to the measurement reporting configured by the network device.

The second auxiliary information includes at least one of:

an identifier of a measurement reporting event;

a type of a signal that triggers the measurement reporting;

a measurement reporting cycle;

a measurement object; or

a time of triggering the measurement reporting.

In the embodiments of the present disclosure, when the terminal reports the auxiliary information to the network device in response to satisfying the preset condition,, the terminal may report the second auxiliary information for indicating and requesting the configuration relevant to the measurement reporting configured by the network device to the network device, to actively request the network device to configure corresponding measurement configuration information and to perform the cell handover, so as to avoid service interruption.

The second auxiliary information includes the identifier of the measurement reporting event. When the preset condition is satisfied, the terminal reports the identifier of the measurement reporting event to the network device, to actively request the network device to configure measurement configuration information including the identifier of the measurement reporting event.

It may be understood that the identifier of the measurement reporting event may be an identifier of any one of events A1-A6, B1-B2, D1, T1, X1, X2, Y1 and Y2. For different events, a threshold or an offset value may also be indicated.

The second auxiliary information includes the type of the signal that triggers the measurement reporting. When the preset condition is satisfied, the terminal reports the type of the signal that triggers the measurement reporting to the network device, to actively request the network device to configure measurement configuration information including the type of the signal that triggers the measurement reporting.

It may be understood that the type of the signal that triggers the measurement reporting may be the RSRP, the RSRQ or the SINR.

The second auxiliary information includes the measurement reporting cycle. When the preset condition is satisfied, the terminal report, the measurement reporting cycle to the network device, to actively request the network device to configure measurement configuration information including the measurement reporting cycle.

It may be understood that the measurement reporting cycle may be single reporting or periodic reporting. The measurement reporting cycle may indicate a cycle length.

The second auxiliary information includes the measurement object. When the preset condition is satisfied, the terminal reports the measurement object to the network device, to actively request the network device to configure measurement configuration information including the measurement object.

It may be understood that the measurement object may be a frequency or an identifier of the target cell, etc.

The second auxiliary information includes the time of triggering the measurement reporting. When the preset condition is satisfied, the terminal reports the time of triggering the measurement reporting to the network device, to actively request the network device to configure measurement configuration information including the time of triggering the measurement reporting.

It needs to be noted that the above embodiments are not exhaustively listed and are only examples of part of the embodiments, and the above embodiments may be implemented alone or in combination with a plurality of embodiments. The above embodiments are merely exemplary and do not constitute as a specific limitation of the protection scope of the embodiments of the present disclosure.

At S52, measurement configuration information sent by the network device according to the second auxiliary information is received.

In the embodiments of the present disclosure, when the preset condition is satisfied, the terminal reports the second auxiliary information for indicating and requesting the configuration relevant to the measurement reporting configured by the network device to the network device. After receiving the second auxiliary information reported by the terminal, the network device may consider the second auxiliary information and send the measurement configuration information to the terminal according to the second auxiliary information, to indicate the terminal to report the measurement result and perform the cell handover, so as to avoid the service interruption of the terminal.

It needs to be noted that in the embodiments of the present disclosure, the S51 and the S52 may be implemented alone or be implemented in combination with any one of other steps in the embodiments of the present disclosure, such as in combination with the S21, and/or the S31 and the S32, and/or the S41 and the S42 in the embodiments of the present disclosure, which is not limited in the embodiments of the present disclosure.

By implementing the embodiments of the present disclosure, in response to satisfying the preset condition, the second auxiliary information is reported to the network device, in which the second auxiliary information is configured to indicate and request the configuration relevant to the measurement reporting configured by the network device, and reporting the second auxiliary information is not triggered based on the measurement reporting condition being satisfied; and the measurement configuration information sent by the network device according to the second auxiliary information is received. In this way, the terminal may actively request the network device to configure corresponding measurement configuration information, to report the measurement result and perform the cell handover, so as to avoid the service interruption of the terminal.

Please refer to FIG. 6, which is a flowchart of another method for reporting information according to the embodiments of the present disclosure.

As shown in the FIG. 6, the method is executed by a terminal, and may include but is not limited to the following steps S61 to S62.

At S61, in response to a preset condition being satisfied, auxiliary information is reported to a network device, in which the auxiliary information is configured to assist the network device to perform mobility management, and reporting the auxiliary information is not triggered based on a measurement reporting condition being satisfied.

The relevant description of the S61 may be referred to a relevant description in the above embodiments, which may not be repeated herein.

At S62, a second timer is started after the auxiliary information is reported to the network device, and reporting the auxiliary information to the network device is stopped within a second timer duration of the second timer.

In the embodiments of the present disclosure, when the preset condition is satisfied, the terminal reports the auxiliary information to the network device, in which the auxiliary information is configured to assist the network device to perform the mobility management, and reporting the auxiliary information is not triggered based on the measurement reporting condition being satisfied; and the terminal starts the second timer after the auxiliary information is reported to the network device, and stops reporting the auxiliary information to the network device within the second timer duration of the second timer, which may avoid the terminal from repeatedly reporting the auxiliary information, and save energy consumption of the terminal.

In some embodiments, the terminal may receive second configuration information from the network device, in which the second configuration information indicates the second timer duration.

In the embodiments of the present disclosure, the terminal receives the second configuration information from the network device, in which the second configuration information indicates the second timer duration. In this way, the terminal starts the second timer after the auxiliary information is reported to the network device, and stops reporting the auxiliary information to the network device within the second timer duration of the second timer, which may avoid the terminal from repeatedly reporting the auxiliary information, and save the energy consumption of the terminal.

It needs to be noted that in the embodiments of the present disclosure, the S61 and the S62 may be implemented alone or be implemented in combination with any one of other steps in the embodiments of the present disclosure, such as in combination with the S21, and/or the S31 and the S32, and/or the S41 and the S42, and/or the S51 and S52 in the embodiments of the present disclosure, which is not limited in the embodiments of the present disclosure.

By implementing the embodiments of the present disclosure, when the preset condition is satisfied, the auxiliary information is reported to the network device, in which the auxiliary information is configured to assist the network device to perform the mobility management, and reporting the auxiliary information is not triggered based on the measurement reporting condition being satisfied; and the second timer is started after the auxiliary information is reported to the network device, and reporting the auxiliary information to the network device is stopped within the second timer duration of the second timer, which may avoid the terminal from repeatedly reporting the auxiliary information, and save the energy consumption of the terminal.

Please refer to FIG. 7, which is a flowchart of another method for reporting information according to the embodiments of the present disclosure.

As shown in the FIG. 7, the method is executed by a network device, and may include but is not limited to the following step S71.

At S71, auxiliary information reported by a terminal is received, in which the auxiliary information is configured to assist the network device to perform mobility management, the auxiliary information is reported by the terminal in the case that a preset condition is satisfied, and reporting the auxiliary information is not triggered based on a measurement reporting condition being satisfied.

In the embodiments of the present disclosure, when the preset condition is satisfied, the terminal may report the auxiliary information to the network device, in which the auxiliary information is configured to assist the network device to perform the mobility management.

The auxiliary information may be information relevant to a requested handover, such as a requested handover indication, a handover target cell, a measurement result of the handover target cell, and/or a handover cause, etc. The auxiliary information may be configuration relevant to measurement reporting configured by the network device, such as an identifier of a measurement reporting event, a type of a signal that triggers the measurement reporting, a measurement reporting cycle, a measurement object, and/or a time of triggering the measurement reporting, etc.

In the embodiments of the present disclosure, when the preset condition is satisfied, the terminal may report the information relevant to the requested handover to the network device and actively apply for the cell handover to complete the cell handover so as to avoid the service interruption. When the preset condition is satisfied, the terminal reports and requests the configuration relevant to the measurement reporting configured by the network device to the network device, and the network device may configure a reasonable measurement reporting condition for the terminal considering the configuration relevant to the measurement reporting reported by the terminal, so that the terminal may complete the cell handover and avoid the service interruption.

It may be understood that reporting the auxiliary information is not triggered based on the measurement reporting condition being satisfied, but the terminal actively reports the auxiliary information.

In the embodiments of the present disclosure, the terminal may perform local measurement on a service quality of a serving cell and/or a neighbour cell, and/or in consideration of its own communication requirements, etc., further determine whether to actively report the auxiliary information to the network device according to a measurement result and/or a communication requirement of the local measurement.

By implementing the embodiments of the present disclosure, the network device receives the auxiliary information reported by the terminal, in which the auxiliary information is configured to assist the network device to perform the mobility management, the auxiliary information is reported by the terminal in the case that the preset condition is satisfied, and reporting the auxiliary information is not triggered based on the measurement reporting condition being satisfied. In this way, the terminal may actively report the information configured to assist the network device for the mobility management and actively perform the cell handover to avoid the service interruption.

In some embodiments, the preset condition includes at least one of:

a condition that an uplink resource scheduled by the network device is not received within a specific duration;

a condition that a downlink resource scheduled by the network device is not received within a specific duration;

a condition that a signal quality of a serving cell is lower than a signal quality threshold and a measurement result is not reported; or

a condition that the signal quality of the serving cell is lower than the signal quality threshold and a handover is not performed.

In the embodiments of the present disclosure, in the condition that the terminal does not receive the uplink resource scheduled by the network device within the specific duration, the terminal reports the auxiliary information configured to perform the mobility management to the network device.

In the embodiments of the present disclosure, in the condition that the terminal does not receive the downlink resource scheduled by the network device within the specific duration, the terminal reports the auxiliary information configured to perform the mobility management to the network device.

It may be understood that when the terminal does not receive the uplink resource and/or the downlink resource scheduled by the network device within the specific duration, the signal quality of the serving cell is good, and the network device does not send the measurement configuration to the terminal, but the terminal does not receive the uplink resource and/or the downlink resource scheduled by the network device within the specific duration. It is indicated that at this time, there are many terminals served by the serving cell, with the communication congestion. In this case, the terminal may report the auxiliary information to the network device to actively apply for the cell handover so as to avoid the service interruption.

In the embodiments of the present disclosure, in the condition that the signal quality of the serving cell is lower than the signal quality threshold and the measurement result is not reported, the terminal reports the auxiliary information configured to perform the mobility management to the networking device.

It may be understood that the signal quality of the serving cell is lower than the signal quality threshold and the measurement result is not reported, which indicates that the measurement reporting condition configured by the network device may be unreasonable. In this case, the terminal may report the auxiliary information to the network device to actively apply for the cell handover so as to avoid the service interruption.

In the embodiments of the present disclosure, in the condition that the signal quality of the serving cell is lower than the signal quality threshold and the handover is not performed, the terminal reports the auxiliary information configured to perform the mobility management to the networking device.

It may be understood that the signal quality of the serving cell is lower than the signal quality threshold and the handover is not performed, which indicates that the target cell may not provide a communication service for the terminal, or information between any two of the terminal, the target cell and the network device may not be accurately sent, etc. In this case, the terminal may report the auxiliary information to the network device to actively apply for the cell handover so as to avoid the service interruption.

It needs to be noted that the above embodiments are not exhaustively listed and are only examples of part of the embodiments, and the above embodiments may be implemented alone or in combination with a plurality of embodiments. The above embodiments are merely exemplary and do not constitute as a specific limitation of the protection scope of the embodiments of the present disclosure.

In some embodiments, the terminal receives first indication information sent by the network device, in which the first indication information indicates the specific duration.

In the embodiments of the present disclosure, in the case that the terminal receives the first indication information sent by the network device and the first indication information indicates the specific duration, the specific duration may be determined, so that the terminal reports the auxiliary information configured to perform the mobility management to the network device in the condition that the uplink resource and the downlink resource scheduled by the network device are not received within the specific duration.

In some embodiments, the network device sends second indication information to the terminal, in which the second indication information indicates the signal quality threshold.

In the embodiments of the present disclosure, in the case that the terminal receives the second indication information sent by the network device and the second indication information indicates the signal quality threshold, the signal quality threshold may be determined, so that the terminal reports the auxiliary information configured to perform the mobility management to the network device in the condition that the signal quality of the serving cell is lower than the signal quality threshold and the measurement result is not reported and/or in the condition that the signal quality of the serving cell is lower than the signal quality threshold and the handover is not performed.

In some embodiments, the auxiliary information includes first auxiliary information for indicating information relevant to a requested handover, in which the first auxiliary information includes at least one of:

a requested handover indication;

a handover target cell;

a measurement result of the handover target cell; or

a handover cause.

In the embodiments of the present disclosure, when the terminal reports the auxiliary information to the network device in response to satisfying the preset condition, the terminal may report the first auxiliary information for indicating the information relevant to the requested handover to the network device to actively apply for the cell handover so as to avoid the service interruption.

The first auxiliary information includes the requested handover indication. When the preset condition is satisfied, the terminal reports the requested handover indication to the network device, to actively apply for the cell handover so as to avoid the service interruption.

The first auxiliary information includes the handover target cell. When the preset condition is satisfied, the terminal reports the handover target cell to the network device, to actively apply to hand over to the handover target cell so as to avoid the service interruption.

The first auxiliary information includes the measurement result of the handover target cell. When the preset condition is satisfied, the terminal reports the measurement result of the handover target cell to the network device, to actively apply to hand over to the handover target cell so as to avoid the service interruption.

The first auxiliary information includes the handover cause. When the preset condition is satisfied, the terminal reports the handover cause to the network device, to actively apply for the cell handover so as to avoid the service interruption.

The handover cause may be that the uplink resource is not received or the downlink resource is not received, a channel quality of the serving cell is poor, or the service does not meet requirements, and so on.

It needs to be noted that the above embodiments are not exhaustively listed and are only examples of part of the embodiments, and the above embodiments may be implemented alone or in combination with a plurality of embodiments. The above embodiments are merely exemplary and do not constitute as a specific limitation of the protection scope of the embodiments of the present disclosure.

In one embodiment, the network device sends a handover command to the terminal according to the first auxiliary information.

In the embodiments of the present disclosure, when the preset condition is satisfied, the terminal reports the first auxiliary information for indicating the information relevant to the requested handover to the network device. After receiving the first auxiliary information reported by the terminal, the network device may consider the first auxiliary information and send the handover command to the terminal according to the first auxiliary information, to indicate the terminal to perform the cell handover, so as to avoid the service interruption of the terminal.

In some embodiments, the network device sends first configuration information to the terminal, in which the first configuration information indicates a first timer duration.

In the embodiments of the present disclosure, the terminal receives the first configuration information sent by the network device and determines the first timer duration of the first timer according to the first configuration information. When the measurement report reported to the network device by the terminal includes the measurement result of the handover target cell, the terminal starts the first timer, and stops reporting the auxiliary information to the network device within the first timer duration of the first timer.

In some embodiments, the auxiliary information includes second auxiliary information for indicating and requesting configuration relevant to measurement reporting configured by the network device, in which the second auxiliary information includes at least one of:

an identifier of a measurement reporting event;

a type of a signal that triggers the measurement reporting;

a measurement reporting cycle;

a measurement object; or

a time of triggering the measurement reporting.

In the embodiments of the present disclosure, when the terminal reports the auxiliary information to the network device in response to satisfying the preset condition, the terminal may report the second auxiliary information for indicating and requesting the configuration relevant to the measurement reporting configured by the network device to the network device, to actively request the network device to configure corresponding measurement configuration information and to perform the cell handover, so as to avoid the service interruption.

The second auxiliary information includes the identifier of the measurement reporting event. When the preset condition is satisfied, the terminal reports the identifier of the measurement reporting event to the network device, to actively request the network device to configure measurement configuration information including the identifier of the measurement reporting event.

It may be understood that the identifier of the measurement reporting event may be an identifier of any one of events A1-A6, B1-B2, D1, T1, X1, X2, Y1 and Y2. For different events, a threshold or an offset value may also be indicated.

The second auxiliary information includes the type of the signal that triggers the measurement reporting. When the preset condition is satisfied, the terminal reports the type of the signal that triggers the measurement reporting to the network device, to actively request the network device to configure measurement configuration information including the type of the signal that triggers the measurement reporting.

It may be understood that the type of the signal that triggers the measurement reporting may be the RSRP, the RSRQ or the SINR.

The second auxiliary information includes the measurement reporting cycle. When the preset condition is satisfied, the terminal reports the measurement reporting cycle to the network device, to actively request the network device to configure measurement configuration information including the measurement reporting cycle.

It may be understood that the measurement reporting cycle may be single reporting or periodic reporting. The measurement reporting cycle may indicate a cycle length.

The second auxiliary information includes the measurement object. When the preset condition is satisfied, the terminal reports the measurement object to the network device, to actively request the network device to configure measurement configuration information including the measurement object.

It may be understood that the measurement object may be a frequency or an identifier of the target cell, etc.

The second auxiliary information includes the time of triggering the measurement reporting. When the preset condition is satisfied, the terminal reports the time of triggering the measurement reporting to the network device, to actively request the network device to configure measurement configuration information including the time of triggering the measurement reporting.

It needs to be noted that the above embodiments are not exhaustively listed and are only examples of part of the embodiments, and the above embodiments may be implemented alone or in combination with a plurality of embodiments. The above embodiments are merely exemplary and do not constitute as a specific limitation of the protection scope of the embodiments of the present disclosure.

In some embodiments, the network device sends to the terminal measurement configuration information according to the second auxiliary information.

In the embodiments of the present disclosure, when the preset condition is satisfied, the terminal reports the second auxiliary information for indicating and requesting the configuration relevant to the measurement reporting configured by the network device to the network device. After receiving the second auxiliary information reported by the terminal, the network device may consider the second auxiliary information and send the measurement configuration information to the terminal according to the second auxiliary information, to indicate the terminal to report the measurement result and perform the cell handover, so as to avoid the service interruption of the terminal.

In some embodiments, the network device sends second configuration information to the terminal, in which the second configuration information indicates a second timer duration.

In the embodiments of the present disclosure, the terminal receives the second configuration information from the network device, in which the second configuration information indicates the second timer duration. In this way, the terminal starts the second timer after the auxiliary information is reported to the network device, and stops reporting the auxiliary information to the network device within the second timer duration of the second timer, which may avoid the terminal from repeatedly reporting the auxiliary information, and save energy consumption of the terminal.

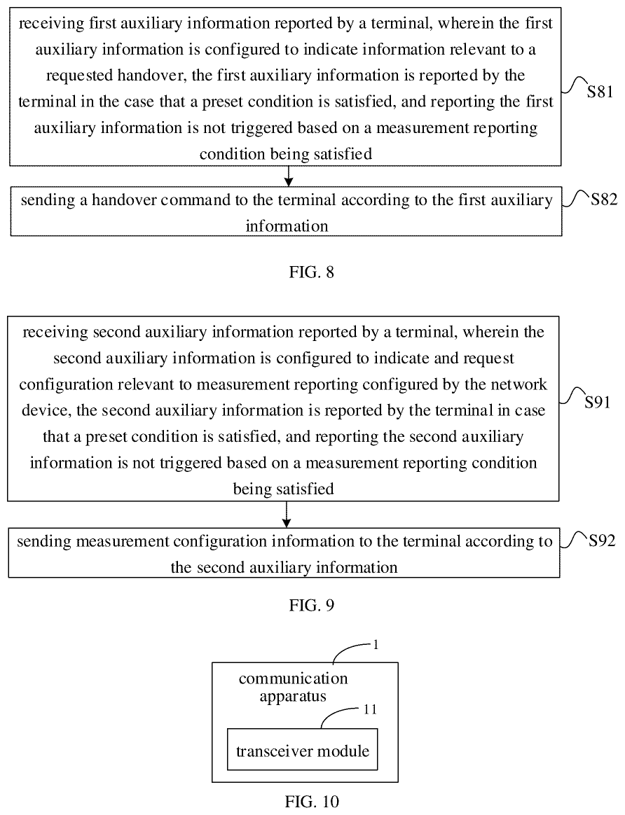

Please refer to FIG. 8, which is a flowchart of another method for reporting information according to the embodiments of the present disclosure.

As shown in the FIG. 8, the method is executed by a network device, and may include but is not limited to the following steps S81 to S82.

At S81, first auxiliary information reported by a terminal is received, in which the first auxiliary information is configured to indicate information relevant to a requested handover, the first auxiliary information is reported by the terminal in the case that a preset condition is satisfied, and reporting the first auxiliary information is not triggered based on a measurement reporting condition being satisfied.

The relevant description of the preset condition may be referred to the preset condition relevant description of the preset condition in the above embodiments, which may not be repeated herein.

In the embodiments of the present disclosure, when the preset condition is satisfied, the terminal reports the first auxiliary information to the network device, in which the first auxiliary information is configured to indicate information relevant to a requested handover.

The relevant description of the first auxiliary information may be referred to the relevant description of the first auxiliary information in the above embodiments, which may not be repeated herein.

At S82, a handover command is sent to the terminal according to the first auxiliary information.

In the embodiments of the present disclosure, when the preset condition is satisfied, the terminal reports the first auxiliary information for indicating the information relevant to the requested handover to the network device. After receiving the first auxiliary information reported by the terminal, the network device may consider the first auxiliary information and send the handover command to the terminal according to the first auxiliary information, to indicate the terminal to perform the cell handover, so as to avoid the service interruption of the terminal.

It needs to be noted that in the embodiments of the present disclosure, the S81 and the S82 may be implemented alone or be implemented in combination with any one of other steps in the embodiments of the present disclosure, such as in combination with the S71 in the embodiments of the present disclosure, which is not limited in the embodiments of the present disclosure.

By implementing the embodiments of the present disclosure, the network device receives the first auxiliary information reported by the terminal, in which the first auxiliary information is configured to indicate the information relevant to the requested handover, the first auxiliary information is reported by the terminal in the case that the preset condition is satisfied, and reporting the first auxiliary information is not triggered based on the measurement reporting condition being satisfied; and the network device sends the handover command to the terminal according to the first auxiliary information. In this way, the terminal may actively apply for the cell handover and perform the cell handover to avoid the service interruption.

Please refer to FIG. 9, which is a flowchart of another method for reporting information according to the embodiments of the present disclosure.

As shown in the FIG. 9, the method is executed by a network device, and may include but is not limited to the following steps S91 and S92.

At S91, second auxiliary information reported by a terminal is received, in which the second auxiliary information is configured to indicate and request configuration relevant to measurement reporting configured by the network device, the second auxiliary information is reported by the terminal in the case that a preset condition is satisfied, and reporting the second auxiliary information is not triggered based on a measurement reporting condition being satisfied.

The relevant description of the preset condition may be referred to the relevant description of the preset condition in the above embodiments, which may not be repeated herein.

In the embodiments of the present disclosure, when the preset condition is satisfied, the terminal reports the second auxiliary information to the network device, in which the second auxiliary information is configured to indicate and request the configuration relevant to the measurement reporting configured by the network device.

The relevant description of the second auxiliary information may be referred to the relevant description of the second auxiliary information in the above embodiments, which may not be repeated herein.

At S92, measurement configuration information is sent to the terminal according to the second auxiliary information.

In the embodiments of the present disclosure, when the preset condition is satisfied, the terminal reports the second auxiliary information for indicating and requesting the configuration relevant to the measurement reporting configured by the network device to the network device. After receiving the second auxiliary information reported by the terminal, the network device may consider the second auxiliary information and send the measurement configuration information to the terminal according to the second auxiliary information, to indicate the terminal to perform the cell handover, so as to avoid the service interruption of the terminal.

It needs to be noted that in the embodiments of the present disclosure, the S91 and the S92 may be implemented alone or be implemented in combination with any one of other steps in the embodiments of the present disclosure, such as in combination with the S71, and/or the S81 and the S82 in the embodiments of the present disclosure, which is not limited in the embodiments of the present disclosure.

By implementing the embodiments of the present disclosure, the network device receives the second auxiliary information reported by the terminal, in which the second auxiliary information is configured to indicate and request the configuration relevant to the measurement reporting configured by the network device, the second auxiliary information is reported by the terminal in the case that the preset condition is satisfied, and reporting the second auxiliary information is not triggered based on the measurement reporting condition being satisfied; and the network device sends the measurement configuration information to the terminal according to the second auxiliary information. In this way, the terminal may actively request the network device to configure corresponding measurement configuration information, to report the measurement result and perform the cell handover, so as to avoid the service interruption.

In the above embodiments of the present disclosure, the methods in the embodiments of the present disclosure are introduced respectively from the perspective of the network device and the terminal. In order to realize the functions of the methods in the above embodiments of the present disclosure, the network device and the terminal may include a hardware structure, and a software module, so that the above functions are implemented in a form of the hardware structure, the software module, or the hardware structure plus the software module. Some of these functions may be implemented in the form of the hardware structure, the software module, or the hardware structure plus the software module.

Please refer to FIG. 10, which is a block diagram of a communication apparatus 1 according to the embodiments of the present disclosure. The communication apparatus 1 in the FIG. 10 may include a transceiver module 11 and a processing module. The transceiver module may include a transmitting module and/or a receiving module. The transmitting module is configured to achieve a transmitting function, the receiving module is configured to achieve a receiving function, and the transceiver module may achieve the transmitting function and/or the receiving function.

The communication apparatus 1 may be a terminal, an apparatus in the terminal, or a device being used in match with the terminal. Or, the communication apparatus 1 may be a network device, an apparatus in the network device, or a device being used in match with the network device.

When the communication apparatus 1 is a terminal, the communication apparatus includes a transceiver module 11.

The transceiver module 11 is configured to in response to a preset condition being satisfied, report auxiliary information to a network device, in which the auxiliary information is configured to assist the network device to perform mobility management, and reporting the auxiliary information is not triggered based on a measurement reporting condition being satisfied.

In some embodiments, the preset condition includes at least one of:

a condition that an uplink resource scheduled by the network device is not received within a specific duration;

a condition that a downlink resource scheduled by the network device is not received within a specific duration;

a condition that a signal quality of a serving cell is lower than a signal quality threshold and a measurement result is not reported; or

a condition that the signal quality of the serving cell is lower than the signal quality threshold and a handover is not performed.

In some embodiments, the transceiver module 11 is further configured to receive first indication information sent by the network device, in which the first indication information indicates the specific duration.

In some embodiments, the transceiver module 11 is further configured to receive second indication information sent by the network device, in which the second indication information indicates the signal quality threshold.

In some embodiments, the auxiliary information includes first auxiliary information for indicating information relevant to a requested handover, in which the first auxiliary information includes at least one of:

a requested handover indication;

a handover target cell;

a measurement result of the handover target cell; or

a handover cause.

In some embodiments, the transceiver module 11 is further configured to receive a handover command sent by the network device according to the first auxiliary information.

In some embodiments, the transceiver module 11 is further configured to in response to a measurement report reported to the network device including the measurement result of the handover target cell, stop reporting the auxiliary information to the network device.

In some embodiments, the transceiver module 11 is further configured to in response to the measurement report reported to the network device including the measurement result of the handover target cell, start a first timer, and stop reporting the auxiliary information to the network device within a first timer duration of the first timer.

In some embodiments, the transceiver module 11 is further configured to receive first configuration information from the network device, in which the first configuration information indicates the first timer duration.

In some embodiments, the auxiliary information includes second auxiliary information for indicating and requesting configuration relevant to measurement reporting configured by the network device, in which the second auxiliary information includes at least one of:

an identifier of a measurement reporting event;

a type of a signal that triggers the measurement reporting;

a measurement reporting cycle;

a measurement object; or

a time of triggering the measurement reporting.

In some embodiments, the transceiver module 11 is further configured to receive measurement configuration information sent by the network device according to the second auxiliary information.

In some embodiments, the transceiver module 11 is further configured to start a second timer after the auxiliary information is reported to the network device, and stop reporting the auxiliary information to the network device within a second timer duration of the second timer.

In some embodiments, the transceiver module 11 is further configured to receive second configuration information from the network device, in which the second configuration information indicates the second timer duration.

When the communication apparatus 1 is a network device, the communication apparatus includes a transceiver module 11.

The transceiver module 11 is configured to receive auxiliary information reported by a terminal, in which the auxiliary information is configured to assist the network device to perform mobility management, the auxiliary information is reported by the terminal in the case that a preset condition is satisfied, and reporting the auxiliary information is not triggered based on a measurement reporting condition being satisfied.

In some embodiments, the preset condition includes at least one of:

a condition that an uplink resource scheduled by the network device is not received within a specific duration;

a condition that a downlink resource scheduled by the network device is not received within a specific duration;

a condition that a signal quality of a serving cell is lower than a signal quality threshold and a measurement result is not reported; or

a condition that the signal quality of the serving cell is lower than the signal quality threshold and a handover is not performed.

In some embodiments, the transceiver module 11 is further configured to send first indication information to the terminal, in which the first indication information indicates the specific duration.

In some embodiments, the transceiver module 11 is further configured to send second indication information to the terminal, in which the second indication information indicates the signal quality threshold.

In some embodiments, the auxiliary information includes first auxiliary information for indicating information relevant to a requested handover, in which the first auxiliary information includes at least one of:

a requested handover indication;

a handover target cell;

a measurement result of the handover target cell; or

a handover cause.

In some embodiments, the transceiver module 11 is further configured to send a handover command to the terminal according to the first auxiliary information.

In some embodiments, the transceiver module 11 is further configured to send first configuration information to the terminal, in which the first configuration information indicates a first timer duration.

In some embodiments, the auxiliary information includes second auxiliary information for indicating and requesting configuration relevant to measurement reporting configured by the network device, in which the second auxiliary information includes at least one of:

an identifier of a measurement reporting event;

a type of a signal that triggers the measurement reporting;

a measurement reporting cycle;

a measurement object; or

a time of triggering the measurement reporting.

In some embodiments, the transceiver module 11 is further configured to send measurement configuration information to the terminal according to the second auxiliary information.

In some embodiments, the transceiver module 11 is further configured to send second configuration information to the terminal, in which the second configuration information indicates a second timer duration.

With respect to the communication apparatus 1 in the above embodiments, specific methods in which each module performs an operation have been described in detail in an embodiment relating to the method and will not be elaborated herein.

The communication apparatus 1 in the above embodiments of the present disclosure achieves a same or similar beneficial effect as the method for reporting information in some of the above embodiments, which is not described herein.

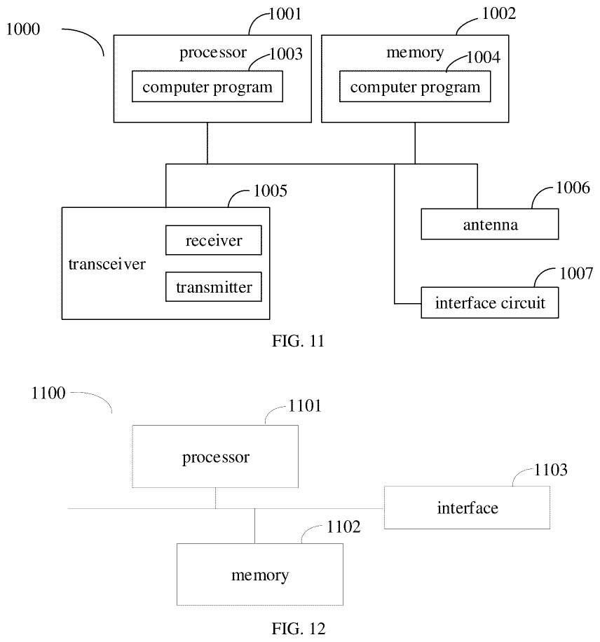

Please refer to FIG. 11, which is a block diagram of another communication device 1000 according to the embodiments of the present disclosure. The communication device 1000 may be a network device, or a terminal, or a chip, a chip system, a processor, etc. that supports the network device to implement the method, or a chip, a chip system, a processor, etc. that supports the terminal to implement the method. The device 1000 is configured to implement the method in the above method embodiments. For details, please refer to the description in the above method embodiments.

The communication device 1000 may include one or more processors 1001. The processor 1001 may be a general-purpose processor or a special-purpose processor. For example, it may be a baseband processor or a central processing unit. The baseband processor is configured to process communication protocols and communication data, and the central processor is configured to control communication devices (such as base stations, baseband chips, terminals, terminal chips, DU or CU, etc.) to execute computer programs and process computer program data.

Optionally, the communication device 1000 may also include one or more memories 1002 on which a computer program 1004 is stored. When the computer program 1004 is executed by the memory 1002, the communication device 1000 performs the method in the above method embodiments. Optionally, the memory 1002 may also store data. The communication device 1000 and the memory 1002 may be set separately or integrated together.

Optionally, the communication device 1000 includes a transceiver 1005 and an antenna 1006. The transceiver 1005 may be called a transceiving unit, a transceiving machine, or a transceiving circuit, etc., to achieve a transceiving function. The transceiver 1005 may include a receiver and a transmitter. The receiver may be called a receiver or a receiving circuit, etc., to achieve the receiving function; and the transmitter may be called a transmitter or a transmitting circuit, etc., to achieve the transmitting function.

Optionally, the communication device 1000 includes one or more interface circuits 1007. The interface circuit 1007 is configured to receive code instructions and transmit the code instructions to the processor 1001. When the code instructions are running on the processor 1001, the communication device 1000 is caused to implement the method in the above embodiments.

When the communication device 1000 is a terminal, the transceiver 1005 is configured to execute the S21 in the FIG. 2; the S31 and the S32 in the FIG. 3; the S41 and the S42 in the FIG. 4; the S51 and the S52 in the FIG. 5; and the S61 and the S62 in the FIG. 6.

When the communication device 1000 is a network device, the transceiver 1005 is configured to execute the S71 in the FIG. 7; the S81 and the S82 in the FIG. 8; and the S91 and the S92 in the FIG. 9.

In one implementation, the processor 1001 may include a transceiver configured to achieve the receiving and transmitting function. For example, the transceiver may be a transceiving circuit, or an interface, or an interface circuit. The transceiving circuit, the interface, or the interface circuit configured to achieve the receiving and transmitting function may be set separately or integrated together. The transceiving circuit, the interface or the interface circuit may be configured to read and write code/data, or the transceiving circuit, the interface or the interface circuit may be configured to transmit signals.

In one implementation, the processor 1001 may store a computer program 1003. When the computer program 1003 is running on the processor 1001, the communication device 1000 is caused to implement the method in the above embodiments. The computer program 1003 may be solidified in the processor 1001. In this way, the processor 1001 may be implemented in hardware.

In one implementation, the communication device 1000 includes a circuit that may achieve the transmitting or receiving or communicating function in the above method embodiments. The processor and transceiver in the present disclosure may be implemented in an integrated circuit (IC), an analog IC, a radio frequency integrated circuit (RFIC), a mixed-signal IC, an application specific integrated circuit (ASIC), a printed circuit board (PCB), an electronic equipment, etc. The processor and transceiver may also be manufactured with various IC process technologies, such as a complementary metal oxide semiconductor (CMOS), nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication device 1000 in the above embodiments may be a network device or a terminal, but the scope of the communication device in the present disclosure is not limited to this, and the structure of the communication device may not be restricted by FIG. 11. The communication device may be an independent device or part of a larger device. For example, the communication device may be:
(1) an independent IC, or a chip, or a chip system or a subsystem;
(2) a collection including one or more IC, optionally, the IC collection may also include storage components for storing data and computer programs;
(3) an ASIC, such as a modem;
(4) modules embedded in other devices;
(5) a receiver, a terminal, an intelligent terminal, a cellular phone, a wireless device, a handheld phone, a mobile unit, a vehicle-mounted device, a network device, a cloud device, an artificial intelligence device, etc.;
(6) others.

For the case where the communication device may be a chip or a chip system, please refer to the FIG. 12, which is a block diagram of a chip according to the embodiments of the present disclosure.

The chip 1100 includes a processor 1101 and an interface 1103. There may be one or more processors 1101, and there may be one or more interfaces 1103.

For the case where the chip is configured to achieve functions of the network device in the embodiments of the present disclosure,

the interface 1103 is configured to receive code instructions and transmitting the code instructions to the processor; and

the processor 1101 is configured to run code instructions to execute the method for reporting information in some of the above embodiments.

For the case where the chip is configured to achieve functions of the terminal in the embodiments of the present disclosure,

the interface 1103 is configured to receive code instructions and transmitting the code instructions to the processor; and

the processor 1101 is configured to run code instructions to execute the method for reporting information in some of the above embodiments.

Optionally, the chip 1100 further includes a memory 1102 for storing necessary computer programs and data.

Those skilled in the art may also understand that the various illustrative logical blocks and steps listed in the embodiments of the present disclosure may be implemented by electronic hardware, computer software, or their combination. Whether such a function is implemented in hardware or software depends on specific applications and design requirements of the overall system. Those skilled in the art may, for each specific application, use a variety of methods to achieve the above function, but such implementation shall not be regarded as going beyond the scope of the protection of the embodiments of the present disclosure.

The embodiments of the present disclosure also provide a system for reporting information. The system includes a communication device as a terminal and a communication apparatus as a network device in the above embodiments in FIG. 10. Or, the system includes a communication device as a terminal and a communication device as a network device in the above embodiments in FIG. 11.

The present disclosure also provides a computer readable storage medium for storing instructions. When the instructions are executed by a computer, functions of any one of the above method embodiments is performed.

The present disclosure also provides a computer program product. When the computer program product is executed by a computer, functions of any one of the above method embodiments is performed.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to embodiments of the present disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The computer-readable storage medium may be any available medium that may be accessed by a computer, or a data storage device such as a server that integrates one or more of the available media, and a data center. The available medium media be a magnetic medium (such as a floppy disk, a hard disk and a magnetic tape), an optical medium (such as a digital video disk (DVD)), or a semiconductor medium (such as a solid state disk (SSD)).

Those skilled in the art may understand that various numbers such as first and second involved in the present disclosure are distinguished merely for convenience of description, and are not intended to limit the scope of embodiments of the present disclosure, but also to indicate an order of precedence.

The term “at least one” in the present disclosure may also be described as one or more, and the more may be two, three, four, or more, which is not limited in the present disclosure. In the embodiment of the present disclosure, for a technical feature, the technical feature in the technical features are distinguished by terms “first”, “second”, “third”, “A”, “B”, “C” and “D”, etc., and the technical features described by the terms “first”, “second”, “third”, “A”, “B”, “C” and “D”, etc. are not in a sequential order or in an order of size.

Corresponding relationships indicated by tables in the present disclosure may be configured or predefined. Values of information in the tables are only examples, and may be configured as other values, which are not limited in the present disclosure. When the corresponding relationship between information and parameters is configured, it is not always necessary to configure all corresponding relationships indicated in tables. For example, in the tables of the present disclosure, corresponding relationships indicated by some rows may not be configured. For another example, appropriate transformations and adjustments, such as splitting and merging, may be made based on the above tables. Names of parameters shown in headers of the tables may be other names understandable by the communication device, and values or representations of the parameters may be other values or representations understandable by the communication device. When the above tables are implemented, other data structures may be used, for example, arrays, queues, containers, stacks, linear lists, pointers, linked lists, trees, graphs, structures, classes, heaps or hash tables may be used.

Predefined in the present disclosure may be understood as defined, predefined, stored, pre-stored, pre-negotiated, pre-configured, solidified or pre-fired.

Those skilled in the related art may realize that, in combination with units and algorithm steps of the examples described in embodiments of the present disclosure, may be implemented by an electronic hardware or a combination of an electronic hardware and a computer software. Whether the functions are executed by the hardware or the software depends on a specific application and a design constraint of the technical solutions. Those skilled in the art may adopt different methods for each specific application to implement the described functions, but such implementation should not be considered as going beyond the scope of the present disclosure.

Those skilled in the art may clearly understand that, a specific working process of a system, an apparatus and a unit described above may refer to a corresponding process in the above method embodiments, which will not be repeated here.

The above are only implementations of the present disclosure. However, the protection scope of the present disclosure is not limited here. Changes and substitutions that may be easily considered by those skilled in the art shall be contained within the protection scope of the present disclosure. Therefore, the protection scope of the present disclosure shall be subject to the protection scope of claims.

1. A method for reporting information, executed by a terminal, comprising:
in response to a preset condition being satisfied, reporting auxiliary information to a network device, wherein the auxiliary information is configured to assist the network device to perform mobility management, and reporting the auxiliary information is not triggered based on a measurement reporting condition being satisfied.

2. The method of claim 1, wherein the preset condition comprises at least one of:
a condition that an uplink resource scheduled by the network device is not received within a specific duration;
a condition that a downlink resource scheduled by the network device is not received within a specific duration;
a condition that a signal quality of a serving cell is lower than a signal quality threshold and a measurement result is not reported; or
a condition that the signal quality of the serving cell is lower than the signal quality threshold and a handover is not performed.

3. The method of claim 2, further comprising one of:
receiving first indication information, sent by the network device, wherein the first indication information indicates the specific duration; or
receiving second indication information, sent by the network device, wherein the second indication information indicates the signal quality threshold.

4. (canceled)

5. The method of claim 1, wherein the auxiliary information comprises at least one of:
first auxiliary information for indicating information relevant to a requested handover, wherein the first auxiliary information comprises at least one of: a requested handover indication; a handover target cell; a measurement result of the handover target cell; or a handover cause; or
second auxiliary information for indicating and requesting configuration relevant to measurement reporting configured by the network device, wherein the second auxiliary information comprises at least one of: an identifier of a measurement reporting event; a type of a signal that triggers the measurement reporting; a measurement reporting cycle; a measurement object; or a time of triggering the measurement reporting.

6. The method of claim 5, further comprising at least one of:
receiving a handover command sent by the network device according to the first auxiliary information; or
receiving measurement configuration information sent by the network device according to the second auxiliary information.

7. The method of claim 1, further comprising:
in response to a measurement report reported to the network device comprising a measurement result of a handover target cell, stopping reporting the auxiliary information to the network device.

8. The method of claim 7, wherein in response to the measurement report reported to the network device comprising the measurement result of the handover target cell, stopping reporting the auxiliary information to the network device comprises:
in response to the measurement report reported to the network device comprising the measurement result of the handover target cell, starting a first timer, and stopping reporting the auxiliary information to the network device within a first timer duration of the first timer.

9. The method of claim 8, further comprising:
receiving first configuration information from the network device, wherein the first configuration information indicates the first timer duration.

10.-11. (canceled)

12. The method of claim 1, further comprising:
starting a second timer after the auxiliary information is reported to the network device, and stopping reporting the auxiliary information to the network device within a second timer duration of the second timer.

13. The method of claim 12, further comprising:
receiving second configuration information from the network device, wherein the second configuration information indicates the second timer duration.

14. A method for reporting information, executed by a network device, comprising:
receiving auxiliary information reported by a terminal, wherein the auxiliary information is configured to assist the network device to perform mobility management, the auxiliary information is reported by the terminal in the case that a preset condition is satisfied, and reporting the auxiliary information is not triggered based on a measurement reporting condition being satisfied.

15. The method of claim 14, wherein the preset condition comprises at least one of:
a condition that an uplink resource scheduled by the network device is not received within a specific duration;
a condition that a downlink resource scheduled by the network device is not received within a specific duration;
a condition that a signal quality of a serving cell is lower than a signal quality threshold and a measurement result is not reported; or
a condition that the signal quality of the serving cell is lower than the signal quality threshold and a handover is not performed.

16. The method of claim 15, further comprising one of:
sending first indication information to the terminal, wherein the first indication information indicates the specific duration; or
sending second indication information to the terminal, wherein the second indication information indicates the signal quality threshold.

17. (canceled)

18. The method of claim 14, wherein the auxiliary information comprises first auxiliary information for indicating information relevant to a requested handover, wherein the first auxiliary information comprises at least one of: a requested handover indication; a handover target cell; a measurement result of the handover target cell; or a handover cause.

19. The method of claim 18, further comprising:
sending a handover command to the terminal according to the first auxiliary information.

20. The method of claim 14, further comprising one of:
sending first configuration information to the terminal, wherein the first configuration information indicates a first timer duration; or
sending second configuration information to the terminal, wherein the second configuration information indicates a second timer duration.

21. The method of claim 14, wherein the auxiliary information comprises second auxiliary information for indicating and requesting configuration relevant to measurement reporting configured by the network device, wherein the second auxiliary information comprises at least one of:
an identifier of a measurement reporting event;
a type of a signal that triggers the measurement reporting;
a measurement reporting cycle;
a measurement object; or
a time of triggering the measurement reporting.

22. The method of claim 21, further comprising:
sending measurement configuration information to the terminal according to the second auxiliary information.

23.-25. (canceled)

26. A terminal, comprising a processor and a memory for storing a computer program, wherein the processor is configured to:
in response to a preset condition being satisfied, report auxiliary information to a network device, wherein the auxiliary information is configured to assist the network device to perform mobility management, and reporting the auxiliary information is not triggered based on a measurement reporting condition being satisfied.

27.-28. (canceled)

29. A network device, comprising a processor and a memory for storing a computer program, wherein when computer program stored in the memory is executed by the processor, the network device is caused to implement the method of claim 14.
